(19) United States
(12) Patent Application Publication
(10) Pub. No.: US 2026/0001621 A1
(43) Pub. Date: Jan. 1, 2026

(54) Integrated System For The Transport Of Passengers Or Goods, Which Comprises A Device For The Rapid Replacement Of Batteries For Vessels

(71) Applicant: GERRISBOATS S.R.L., Lavagna (IT)

(72) Inventors: Massimo VERME, Lavagna (IT); Roberto ROSSI, Lavagna (IT)

(73) Assignee: GERRISBOATS S.R.L., Lavagna (IT)

(21) Appl. No.: 19/106,334

(22) PCT Filed: Aug. 3, 2023
(86) PCT No.: PCT/IB2023/058559

§ 371 Date: Feb. 25, 2025

(30) Foreign Application Priority Data
Sep. 1, 2022 (IT) 102022000017979

(51) Int. Cl. B63B 1/24; B60L 53/80; B63B 1/12; B63B 1/26; B63B 1/28; B63B 35/00; B63B 81/00; B63C 1/12; B63H 21/17; B63H 21/20

(52) U.S. Cl. CPC B63B 1/242; B60L 53/80; B63B 1/121; B63B 1/26; B63B 1/286; B63B 81/00; B63C 1/12; B63H 21/17; B63H 21/20; B63B 2035/004; B63H 2021/205

(57) ABSTRACT

An integrated passenger or goods transport system, comprising: a vessel (10) capable of maintaining itself at a fixed height with respect to the floating surface (100), in all conditions of speed and sea state. A system capable of supporting the vessel once it has rested thereon (31). A quick-release coupling system (50) of the pylon (14) and the submerged body (11), in which the propulsion system (20, 22 and 23), the drive system of the wings (12) and the rudder (21), the batteries (19) are contained. A system (70) for recovering and moving the submerged body (11) and the pylon (14) when they are released from the upper part of the vessel (16). This system (70), consisting of an arm having two movements, one in the vertical direction and one in the transverse direction, is also capable of sliding longitudinally on a trolley (71). Once the arm is engaged to the lower part of the vessel, the electrical and hydraulic connections are also restored: this makes it possible to charge the battery, download data for diagnostics and maintenance.

The present invention relates to an integrated system for the transport of passengers or goods based on a vessel described by a previous invention WO2021/234748. Therefore, the vessel constitutes the known art. Such a vessel comprises one or more submerged bodies which generate a hydrostatic thrust in all navigation conditions, a wing system which generates a hydrodynamic thrust only when the vessel is in motion and exceeds the take-off speed, an upper portion of the vessel provided with a hull and a superstructure, in which passengers and goods are housed, and in which the control panel is placed, one or more pylons which connect the torpedo and the wings to the vessel, and finally moving volumes which rise and fall to contribute to keeping the vessel raised when it is stationary or moving slowly at a speed lower than that of take-off. In practice, the upper part of the vessel is capable of maintaining a fixed height above the surface of the sea, both at cruising speed, supported by submerged bodies and by wings, and at low or stationary speeds, supported by submerged bodies and those moving. In particular, the present invention relates to an infrastructure for disembarking and embarking passengers or goods, which, together with the peculiar feature of this vessel to navigate at a fixed height in a stable manner in all speed and sea conditions, allow the rapid replacement of batteries and routine maintenance. The final object is to optimise the size of the batteries in order to be able to cover a stretch between two or more landings. Once the vessel is docked, it can disembark the passengers and replace the batteries. The replaced batteries will remain at the landing for recharging, while the vessel with the recharged batteries will continue to the next landing. Obviously, the recharging time of the batteries must be that which elapses between the docking of two vessels. Thereby the weight of the batteries will be the minimum necessary and the vessel will be light. The possibility of changing the batteries in little time increases the autonomy which will thereby become infinite.

The drawbacks of a hybrid system, in other words provided with internal combustion engines and electric motors powered by batteries, are evident. During navigation, the internal combustion engines push the vessel to cruising speed and use the excess power part to charge the batteries. During the last few miles before docking, the vessel uses the electric motor. Such a system is inefficient from the point of view of efficiency and energy balance, because it is not optimized for either internal combustion navigation or for electric navigation.

The drawbacks of a fully electric system are that it has a limited autonomy, with very long battery charging times, with respect to the stopping time.

The problem to be solved by the present invention is to make a system in which it is possible to: quickly disembark passengers. Release a part of the vessel in which the batteries are contained (in one of the possible embodiments the batteries are contained in the submerged body and the pylon is flanged to the upper part of the vessel). Move the upper part of the vessel onto a pylon and a submerged body, containing the charged batteries. Again fix the lower part to the upper one. Quickly board passengers and continue navigation. The batteries released with the pylon and the submerged body are charged, waiting for the next vessel to arrive.

The problem of the low efficiency of the hybrid system, or of the low autonomy, and of the long charging times of the fully electric system is therefore solved with an integrated system according to claim 1, in which a vessel capable of maintaining a fixed height, docks at a station, unloads the goods or passengers, replaces part thereof in which the batteries are contained, boards passengers for the next destination, and departs for the next landing, thereby obviating the problems of the prior art.

Further features and advantages of the integrated navigation system according to the present invention will be apparent from the following description of a preferred embodiment thereof, given by way of non-limiting example, with reference to the accompanying figures, in which:

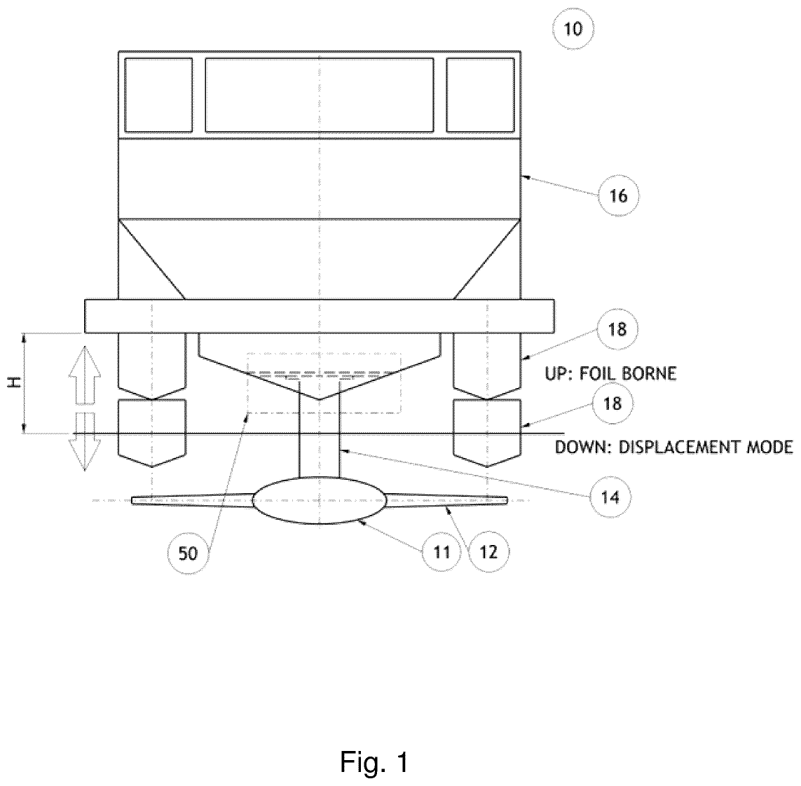

FIG. 1 is a front view of the vessel;

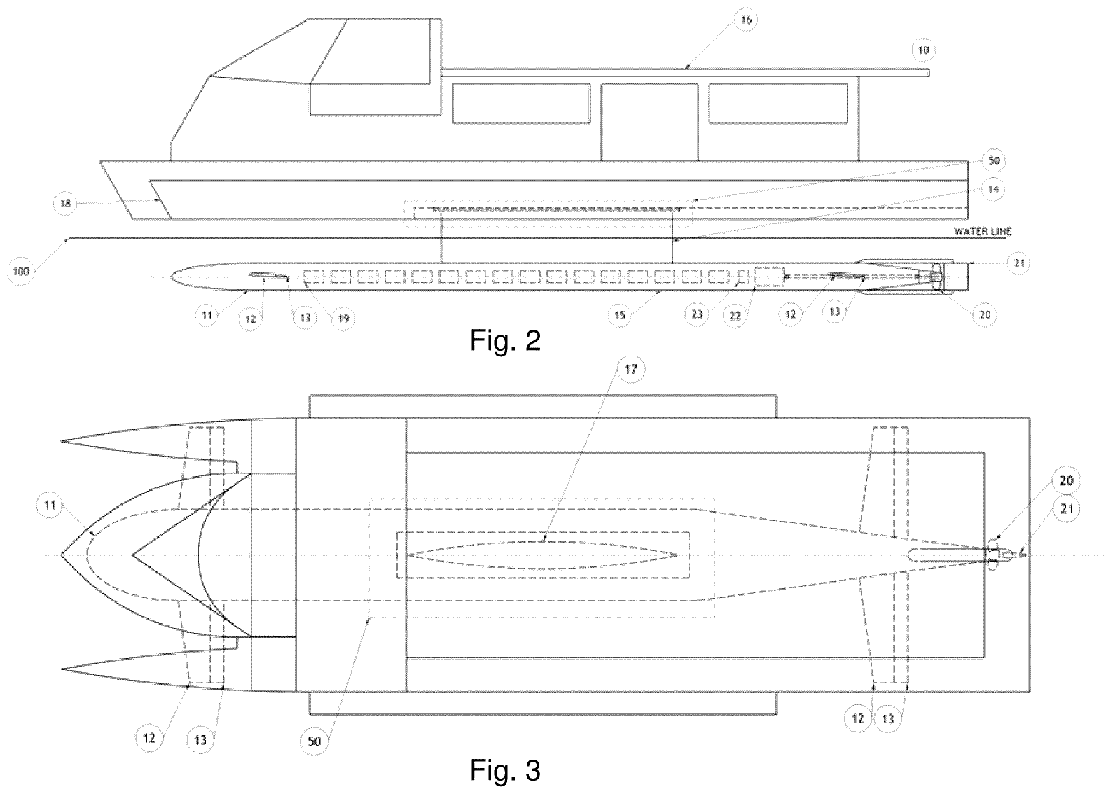

FIG. 2 is a side view of the vessel;

FIG. 3 is a top view of the vessel;

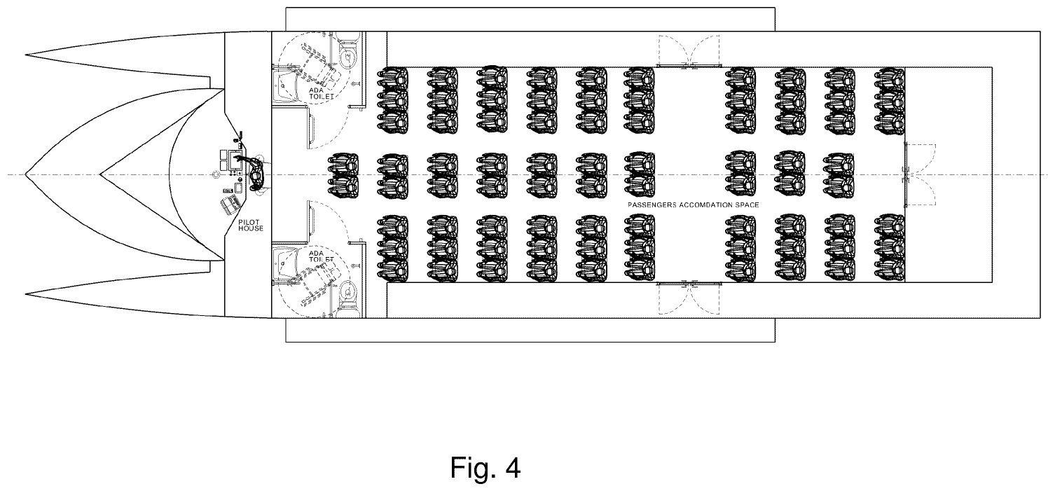

FIG. 4 is a top view of the vessel showing the internal layout, in particular the space for 80 passengers;

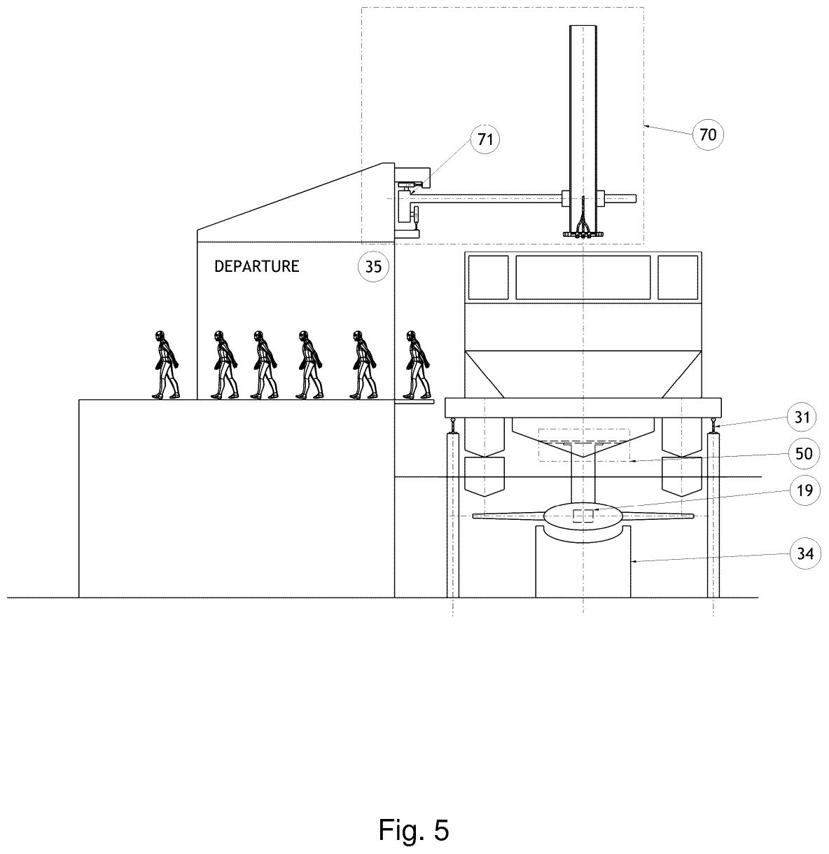

FIG. 5 is a front view of the integrated system with the vessel in the arrival or departure position;

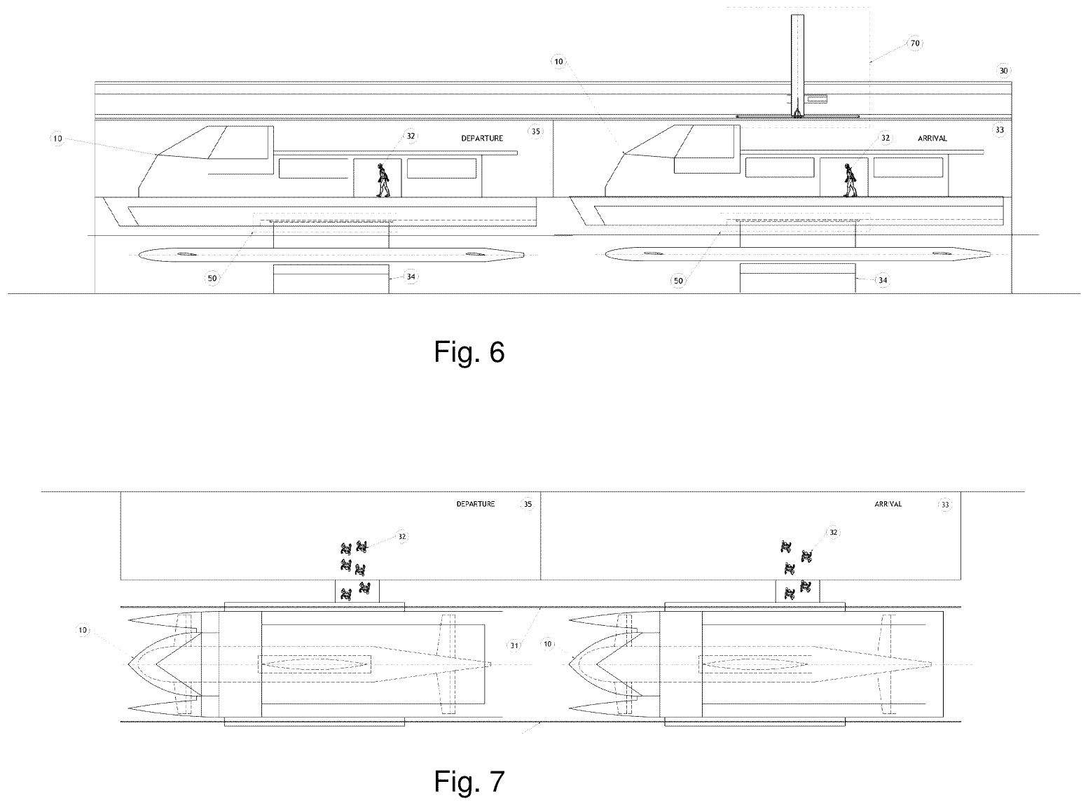

FIG. 6 is a side view of the integrated system with the vessel in the arrival, and departure position;

FIG. 7 is a top view of the integrated system with the vessel in the arrival, and departure position;

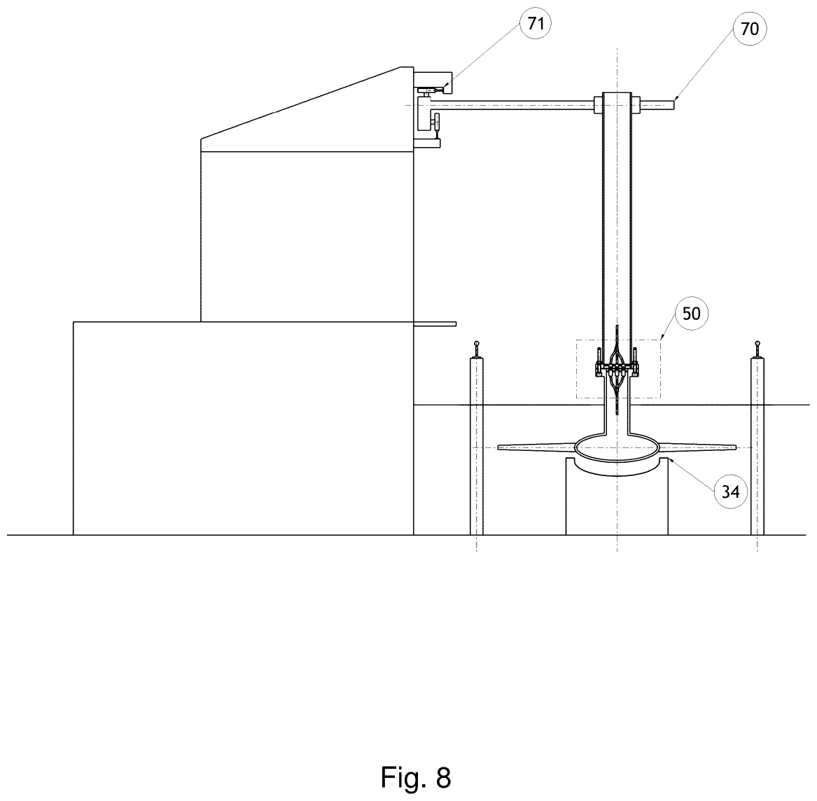

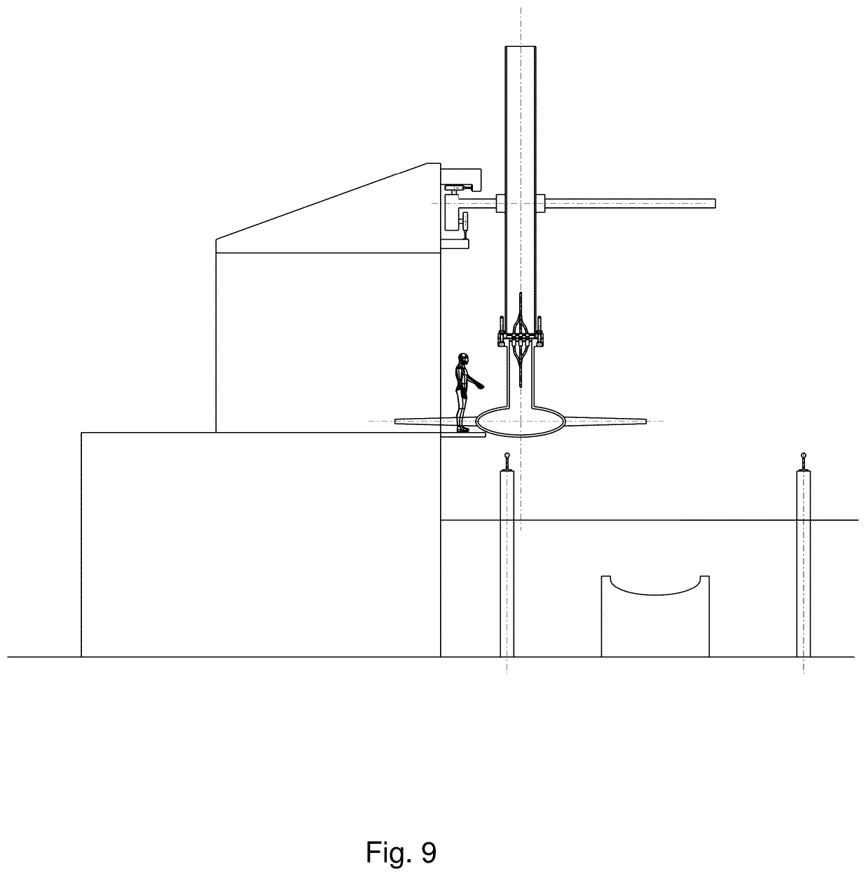

FIG. 8 is a front view of the integrated system showing the movement and charging system of the part of the vessel containing the batteries.

FIG. 9 is a front view of the integrated system showing the movement system which carries the lower part of the vessel to an area where maintenance can easily be performed.

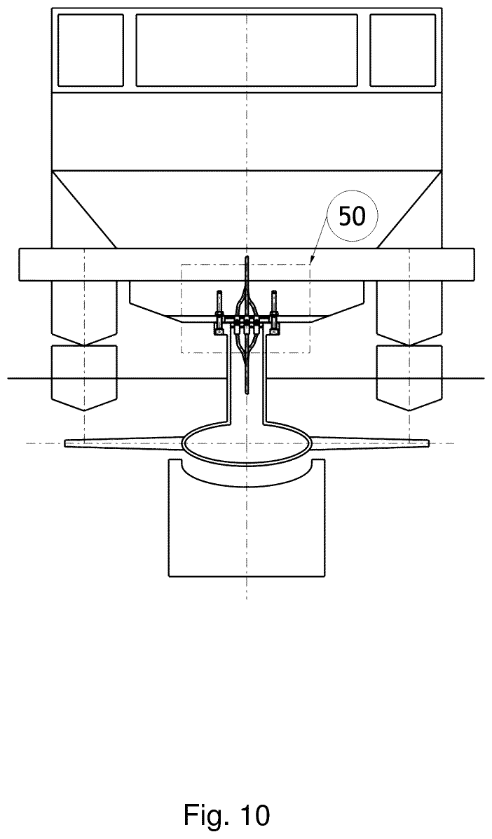

FIG. 10 is a section of the vessel at the quick-release coupling system, in which the lower and upper parts are connected to each other.

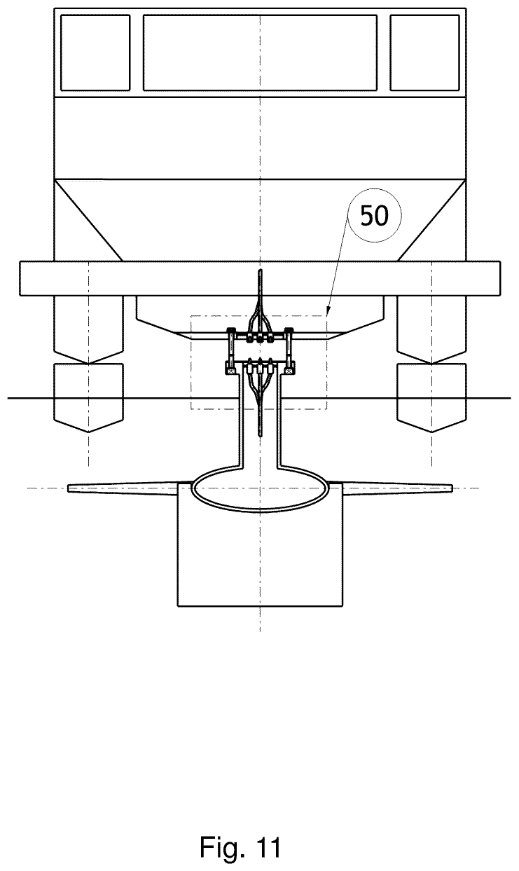

FIG. 11 is a section of the vessel at the quick-release coupling system, in which the lower and upper parts are disconnected from each other. The lower part rests on the saddle but the nuts are still gripping on tie rods.

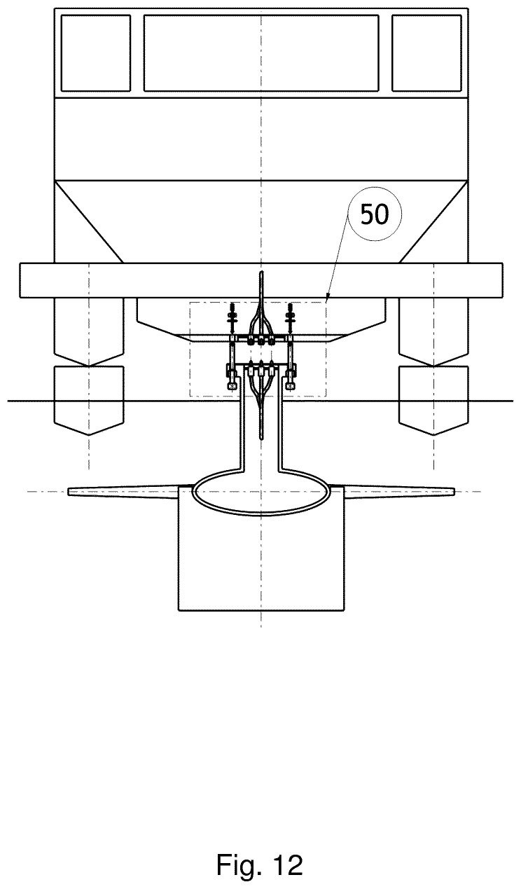

FIG. 12 is a section of the vessel at the quick-release coupling system, in which the lower and upper parts are disconnected from each other. The lower part rests on the saddle, the nuts have been removed, and the tie rods have been lowered to allow the displacement of the vessel.

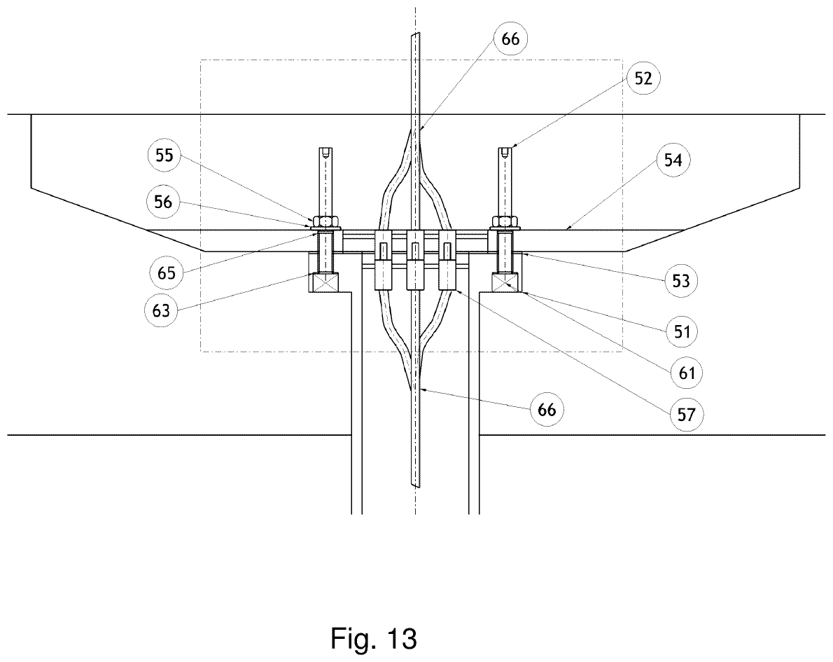

FIG. 13 is a detailed section of the quick-release coupling system, in which the lower and upper parts of the vessel are connected to each other.

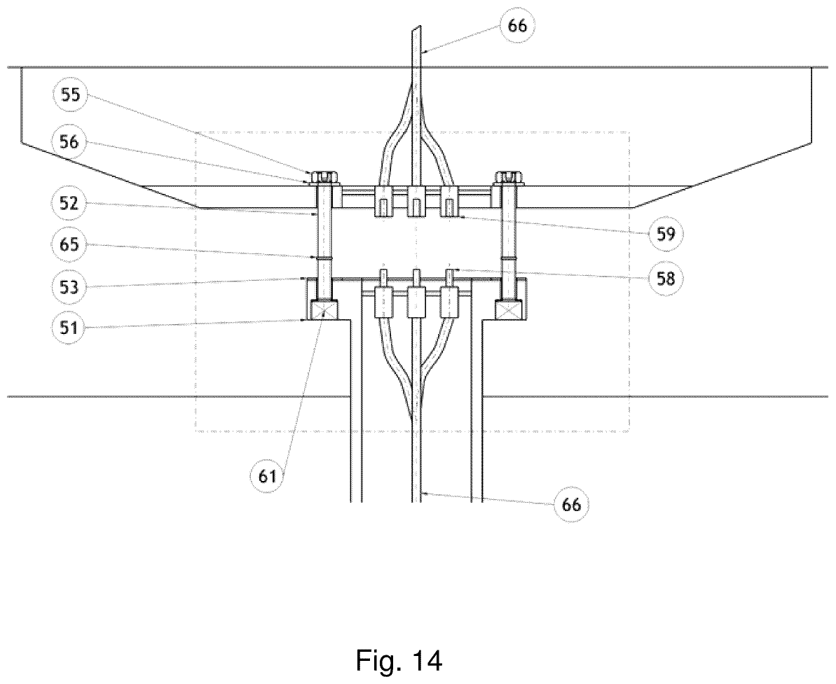

FIG. 14 is a detailed section of the quick-release coupling system, in which the lower and upper parts of the vessel are disconnected from each other. The lower part rests on the saddle but the nuts are still gripping on tie rods.

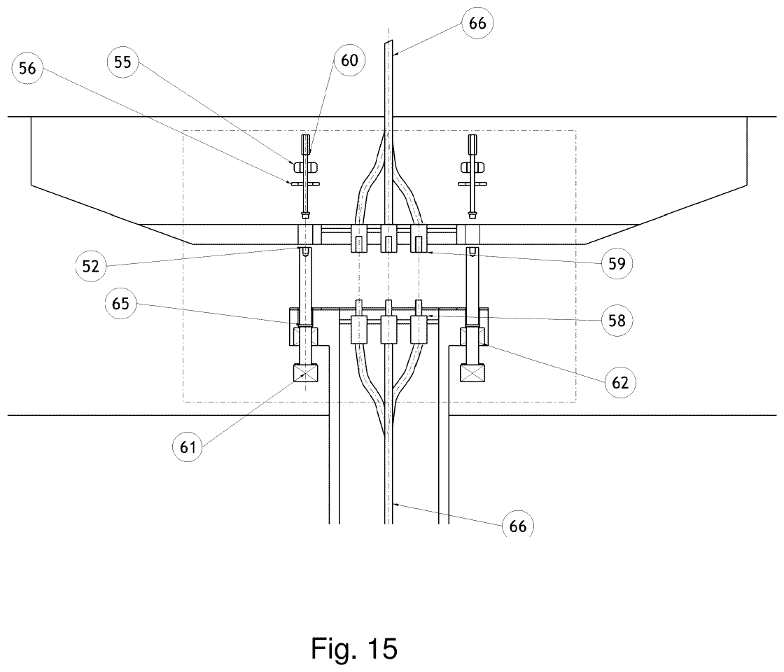

FIG. 15 is a detailed section of the quick-release coupling system, in which the lower and upper parts of the vessel are disconnected from each other. The lower part rests on the saddle, the nuts have been removed, and the tie rods have been lowered to allow the displacement of the vessel.

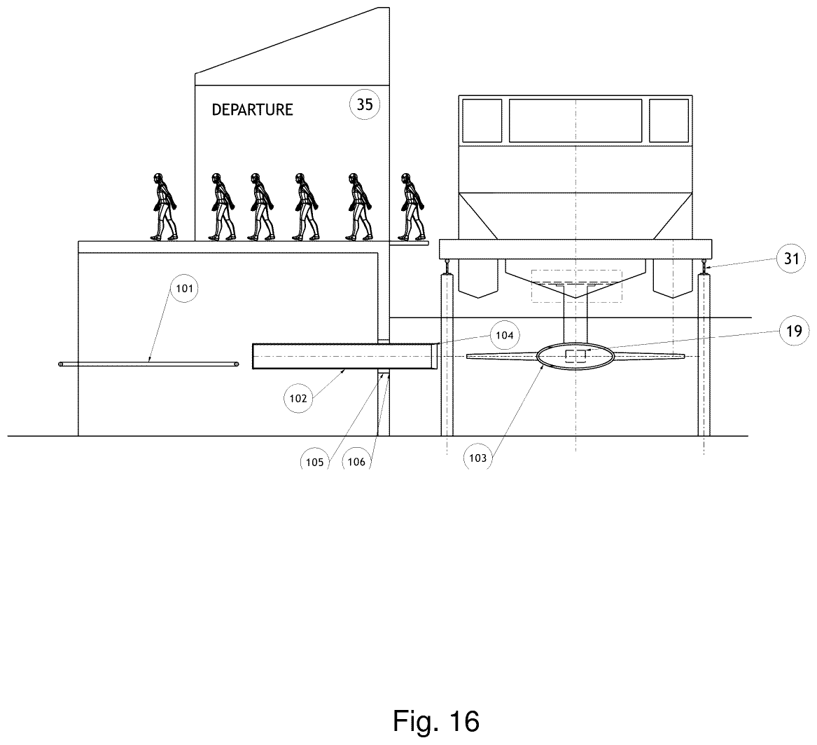

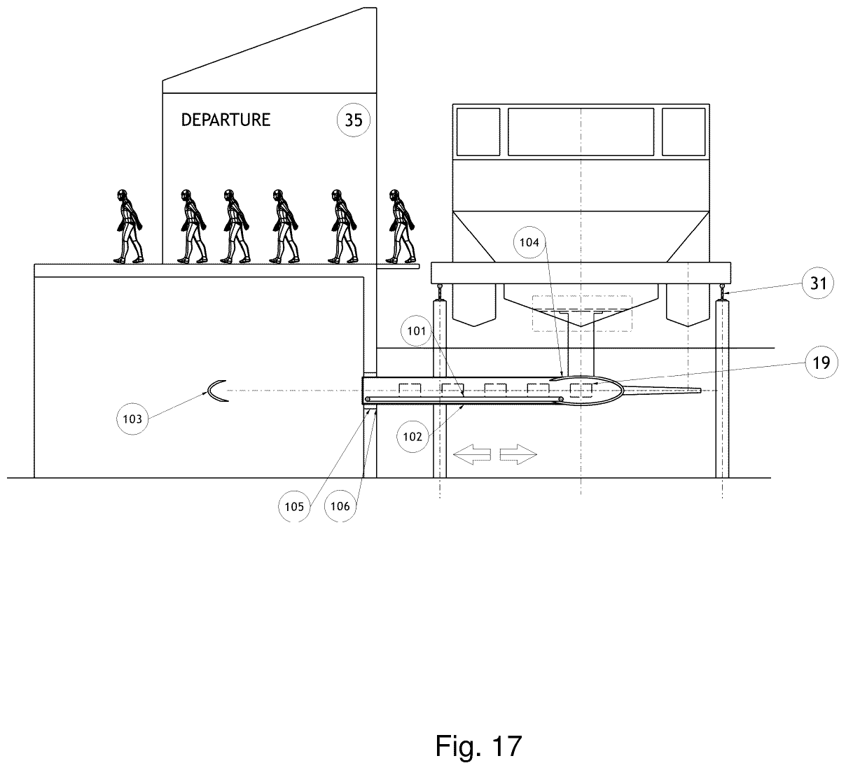

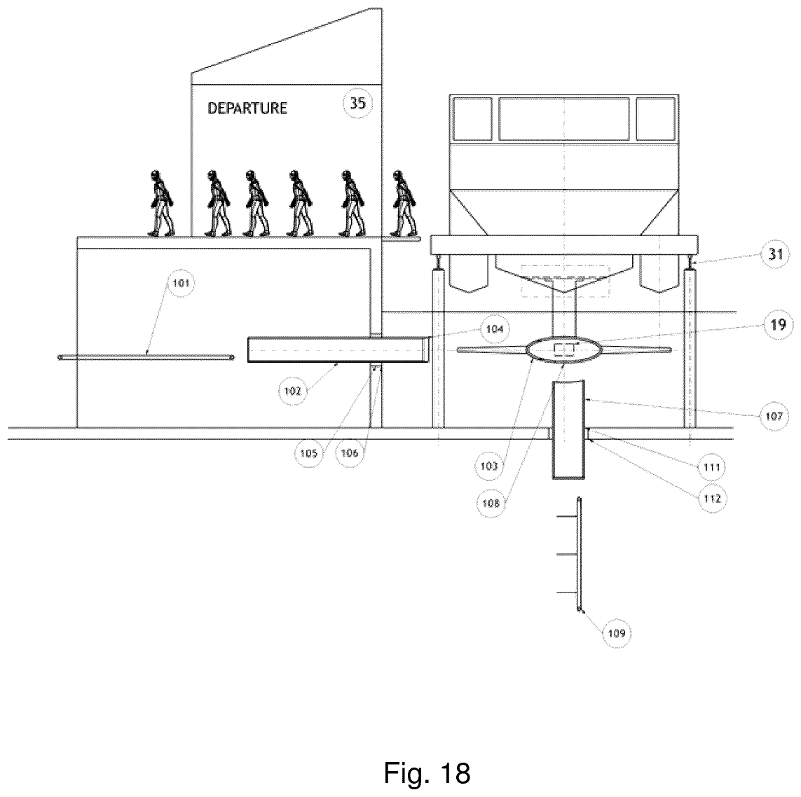

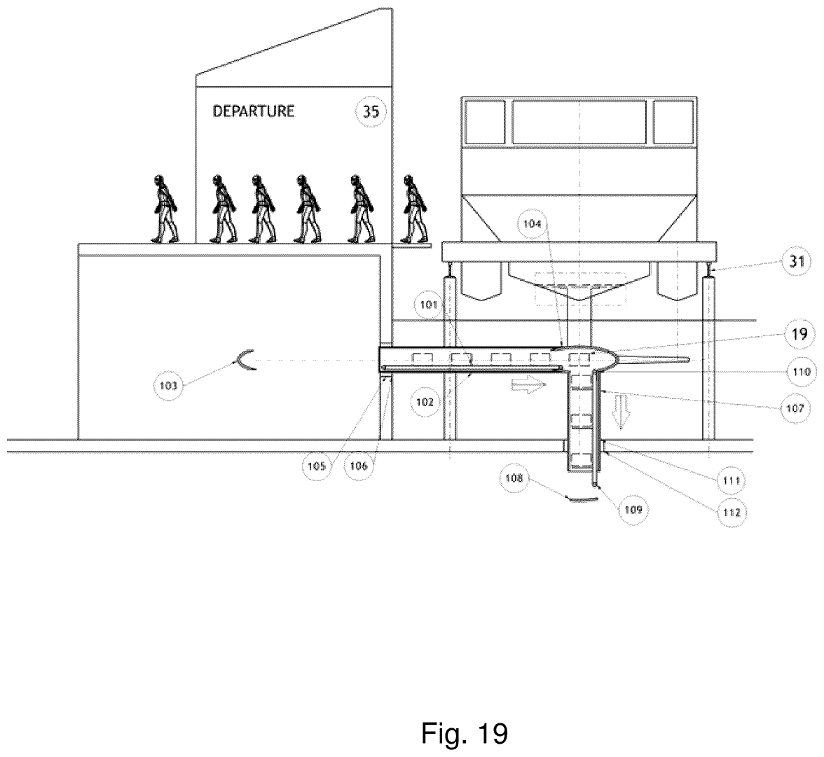

FIGS. 16,17,18,19 show an embodiment of the invention in which the lower part of the vessel is not disassembled but the batteries are replaced by means of conveyor belts contained in a movable pipe.

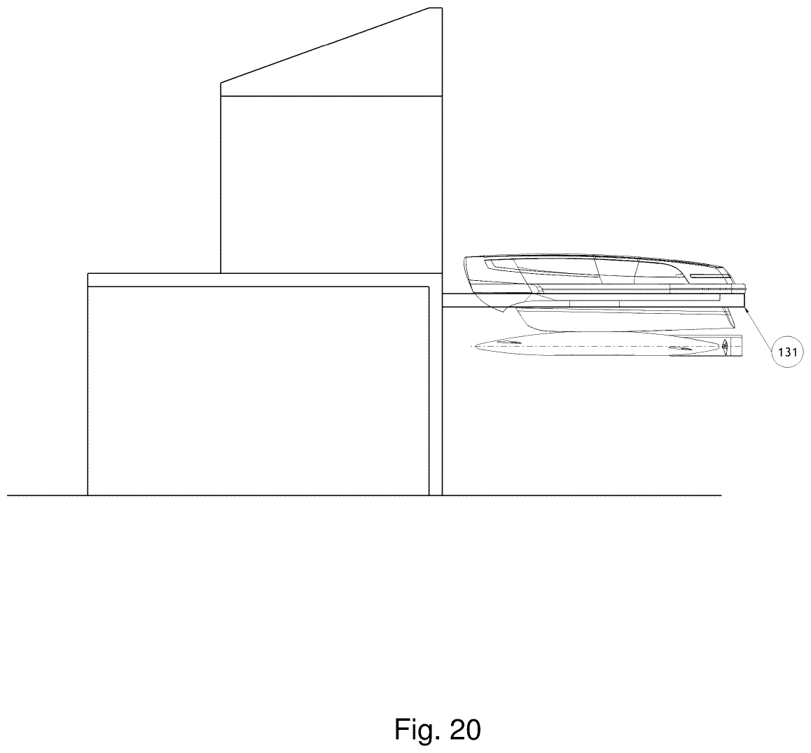

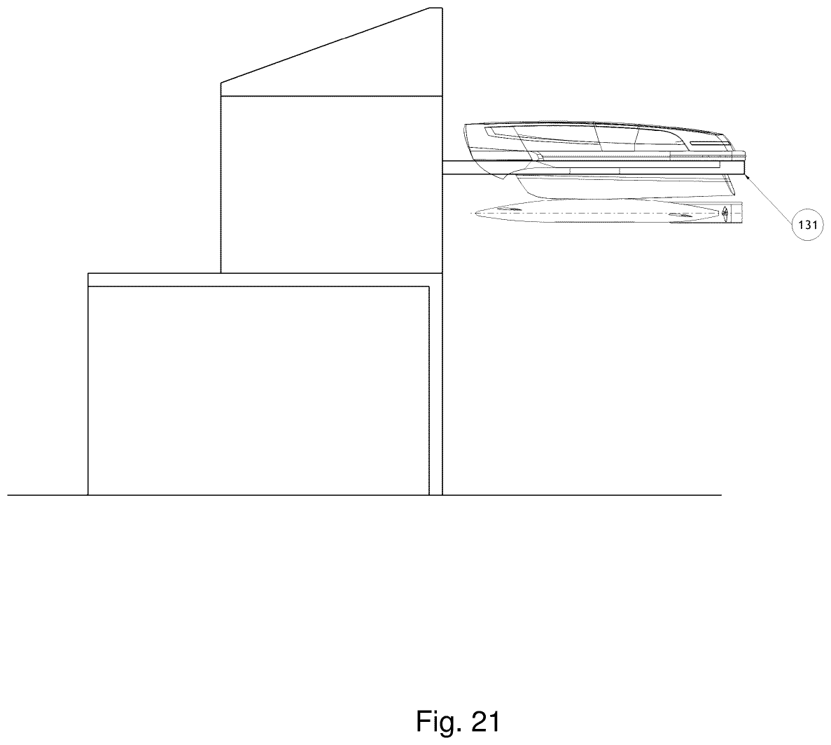

FIGS. 20,21 show an embodiment of the invention where the vessel is smaller and the rails carry out the function of forks of a forklift to lift the vessel.

With reference to the accompanying drawings, it should be noted that the integrated system is generally identified with 30, the vessel with 10, the quick-release coupling system with 50, and the movable arm for the displacement of the pylon and the submerged body with 70.

With particular reference to FIGS. 1 to 4, the vessel comprises a submerged body 11, provided with wings 12, which can be totally movable or partly fixed and provided with a flap 13 on the trailing edge of the wings, a pylon 14 which connects the lower part of the vessel 15 to the upper one 16, provided among other things with a very reduced floating surface 17, the upper part of the vessel 16, movable bodies 18 (or side hulls) capable of moving downwards or upwards, and maintaining the upper part of the vessel at a fixed height even at low speeds or with a fixed vessel. Upon departure, the upper part of the vessel is kept raised by the lateral bodies appropriately moved downwards. Once the floating bodies are lowered, they oscillate around a position of equilibrium and are responsible for the stability of the upper part of the vessel. A control system provided with inertial and height sensors determines the position of the vessel with respect to the floating surface and its inclination in the transverse (roll) and longitudinal (pitch) direction. When the vessel 10 is stationary, as a function of the position of the upper part 16, with respect to the sea surface, the control system manages the position of the floating bodies 18 in order to maintain the upper part of the vessel 16 at a predetermined height and in a horizontal position. The heeling effect of the waves is thus contrasted by the action of the floating bodies 18 which immerse or rise so as to modulate the contrasting force. When the vessel is in motion, and exceeds the take-off speed, it is instead the wings which support the weight of the vessel instead of the floating bodies, and the control system manages the angular position of the wings 12 (if totally movable) or flaps 13 (if partially fixed), so as to modulate the hydrodynamic lift on each thereof and keep the vessel at a fixed height in a horizontal position. In this case, the heeling effect of the waves is contrasted by the modulation of the hydrodynamic lift on the wings.

In addition to the wings, the vessel has other appendages such as the propulsive propeller 20, and the rudder 21.

In a preferred configuration the batteries 19, the propulsion motor 22 and its driver 23, the wing and rudder actuation system, the power electronics for actuator control, all the necessary auxiliary systems (cooling system, bilge pumps, fans and extractors) are housed in the torpedo. The feature of the vessel, which flies at a fixed height in all sea and speed conditions, allows it to dock safely and gently on a platform. In a preferential but not exclusive solution, the landing station 30 consists of two rails 31 placed at a height such as to allow the vessel to rest thereon above the flight height. The vessel 10 approaches the station supported by the wings 12, slows down and lowers the floating bodies 18, continuing low-speed navigation at the same flight height until resting on the rails 31. If necessary, the floating bodies raise or lower the vessel in order to land accurately and without bumps on the rails. At this point the passengers 32 can disembark in the first section of the station and move away 33. Once the passengers have disembarked, the crew, acting on the quick-coupling system 50, release the pylon 14 and the submerged body (torpedo-shaped) 11 with the wings 12 resting on a saddle 34. Once released, the pylon 14 and the submerged body 11, the vessel 10 advances on the rail 31 up to the section 35 of the next station, the passenger boarding station. In the next station there is a pylon 14 and a submerged body 11, inside which there are the charged batteries 19. The pylon and the submerged body are resting on a saddle 34. The crew on-board, by means of the quick-coupling system 50, connects the rest of the vessel 16 to the pylon 14 and to the submerged body 11. Once the two parts are fixed, the waiting passengers 32 can board and the vessel frees the landing station 30. At this point, an arm 70 placed on a trolley 71 which moves between the two sections 33 and 35, engages the pylon 11 and the submerged body 14 containing the discharged batteries, exploiting the same quick-coupling system 50 used to fix it to the vessel. Once engaged to the arm, the charging process can begin, and furthermore the submerged body 11 and the pylon 14 can be lifted out of the water to be cleaned or to proceed with other maintenance activities. Before the next vessel arrives, the pylon and the submerged body are placed in the second section of the landing station, always exploiting the arm 70.

In a preferred but not exclusive solution, the quick-coupling system consists of a flange placed in the upper part of the pylon 51, with a certain number of tie rods 52. The tie rods are of the captive type, in other words once the bolt has been removed they can descend, until the flange 54 is released on the vessel, and allow the vessel to advance, but not fall away, separating from the flange of the pylon 51. In a preferred version, the impossibility of loss is ensured by a seeger ring 65 placed in the middle of the stem of the tie rod. A peripheral gasket 53 is placed on the flange to ensure the watertightness of the coupling. There is a perforated flange 54 on the vessel, which couples with the flange on the pylon 51. The tie rods enter the vessel through the holes of the flange 54 and are fixed with nuts 55 and washers 56. All the connectors 57, male on the pylon 58, female on the vessel 59 or vice versa, are placed on in the centre of the flange for the electrical or hydraulic connections of the cables and pipes 66. To lift the captive tie rods and allow the nuts to be screwed from the upper part only, the crew on-board can use a special tool 60 from inside the vessel, or the tie rods can be lifted by an automatic system once the vessel is placed above the pylon flange. In the engagement step, by pulling the nuts 55 on the tie rods 52, the flange of the pylon 51 goes to crush the gasket 53 on the flange of the vessel 54, forcing the male connectors 58 to engage the female connectors 59. Each tie rod is provided with a square section 61 which couples with a square seat in the flange 62. This allows the nut to be screwed only from above the vessel, because it is thereby unnecessary to hold the tie rod with a wrench from below the vessel. A gasket 63 below the head of the tie rod prevents water from entering when the tie rod is normally tightened. The quick-coupling system connects the pylon to the vessel mechanically, and at the same time connects both the power cables for charging the battery, and the signal cables for actuating the wing system, the rudder, the propulsion engine and all the necessary auxiliary systems which are housed in the submerged body. During the release step, by unscrewing the nuts, the pylon and the submerged body are lowered until they rest on the saddle. Once the pylon and submerged body are safely on the saddle, it is possible to remove the nuts and let the tie rods drop, which will still be retained by the seeger ring.

In a subsequent configuration, the lower part of the vessel can be kept fixed to the upper part but the batteries can be replaced by means of a conveyor belt 101 contained in a movable pipe 102 which exits from the jetty of the station and whose movable end adheres to the submerged body, at a hatch 103, interposing a gasket 104. Between the movable pipe and the jetty wall there is a gasket 105 and a guide 106 for ensuring alignment and watertightness. Once the seal is made between the pipe and the submerged body, the pipe is emptied of water and the hatch can be opened, allowing access to the submerged body to replace the batteries.

In a subsequent configuration, another pipe 107 exits from the bottom of the station and adheres to the submerged body at a hatch 108 in the lower part. The charged batteries are removed through the hatch on the bottom, with the aid of a vertical conveyor belt 109, while those charged are inserted laterally, so as not to cross the path and reduce the replacement time.

The vertical pipe also adheres to the submerged body, interposing a gasket 110, while between the bottom and the pipe there is a guide 112 and a gasket 111.

In a subsequent configuration, the size of the vessel is smaller (for example, it could have the size of a yacht tender of 7-10 metres and a capacity of 12 passengers) and the two rails 131 can be positioned perpendicular to the mooring station, i.e., to the ship, like the forks of a forklift. The vessel can only rise on the two forks and be lifted to replace the batteries or the entire lower part, consisting of submerged body and central pylon.

1. An integrated maritime transport system with embarkation, disembarkation and rapid propulsion unit and energy storage replacement station, comprising:
a hybrid or full-electric propulsion vessel provided with one or more submerged torpedo-shaped bodies containing both the propulsion and control apparatus, as well as energy storage devices, whether stored in tanks or batteries, in addition to containing auxiliary systems,
an upper platform of the vessel, connected to said torpedo-shaped body by means of one or more pylons, on which the passengers or goods are housed,
one or more movable floating bodies capable of moving and lifting the vessel even at low speeds or when the vessel is stationary,
one or more stations for embarking, disembarking, and changing the torpedo-shaped body
characterized in that it comprises,
a quick-release system of the pylon or submerged torpedo-shaped body,
a device at which the platform of the vessel rests prior to the release operation of the torpedo-shaped body,
a saddle for receiving said torpedo-shaped bodies and possibly the relative pylons, when they are released from the platform,
a second saddle for accommodating the submerged torpedo-shaped body and the replacement pylon, before being engaged again to the next vessel,
a system for moving the vessel from the release station to that of engagement,
a system for the quick coupling and movement of the pylon and the submerged body from the release station, to the engagement station,
a system for charging the batteries.

2. The system according to claim 1, characterized in that the vessel is provided with one or more wings which are completely movable or partly fixed and provided with flaps on the trailing edge, capable of supporting the vessel at the flight height once the take-off speed has been exceeded.

3. The system according to claim 1, characterized in that the platform on which the vessel rests comprises two rails on which trolleys which transport the vessel slide from the section of unloading goods or passengers, to the section of loading goods or passengers.

4. The system according to claim 1, characterized in that the quick-coupling system comprises an upper flange placed in the upper part of the pylon provided with captive tie rods, and a perforated flange placed in the vessel, pulling with nuts the tie rods from the upper part of the vessel the flange and pressing a gasket and forcing the electrical connections to engage, the tie rods being provided with a square part for tightening them from the upper part of the vessel and a gasket for sealing against the entrance of water.

5. The system according to claim 1, characterized in that it has a trolley which slides on rails, placed in the upper part of the landing, which moves an extendable arm capable of engaging the upper flange of the pylon, such a system allowing both the lifting and the displacement of the pylon and of the submerged body from a first saddle to another, and the engagement of the electrical connections and consequently charging the batteries and downloading data for maintenance.

6. The system according to claim 1, characterized in that the captive tie rods are lifted with a special tool from inside the vessel.

7. The system according to claim 1, characterized in that the captive tie rods are lifted with an automatic system.

8. The system according to claim 1, provided with a manual or robotic system for changing only the battery pack comprising one or more movable pipe arms which rest on the torpedo-shaped body, expelling water where submerged, and moving both the used and the new charged battery pack therein.

9. The system according to claim 1, characterized in that the vessel is moved by a fork retaining system which lifts and maintains the platform of the vessel in a determined and emerged position, moving the replacement torpedo-shaped body.

10. The system according to claim 1, wherein said embarkation, disembarkation and rapid replacement station comprises a compartment obtained inside a further vessel, which compartment comprises one or more functional units aimed at the movement and/or operation of said hybrid or full-electric propulsion vessel.

11. The system according to claim 3, characterized in that the captive tie rods are lifted with an automatic system.
